(19) United States
(12) Patent Application Publication
(10) Pub. No.: US 2006/0232815 A1
(43) Pub. Date: Oct. 19, 2006

(54) Apparatus and method for printing image

(75) Inventor: Masatoshi Matsuhira, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/391,201

(22) Filed: Mar. 29, 2006

(30) Foreign Application Priority Data
Mar. 29, 2005 (JP) 2005-094817
Mar. 8, 2006 (JP) 2006-062156

(51) Int. Cl. G06F 3/12

(52) U.S. Cl. 358/1.15; 358/527

(57) ABSTRACT

A coded image data to be printed is specified. The coded image data is decoded to generate a preview image. The preview image is displayed. It is generated print Information to be required to print an image corresponding to the preview image without an instruction for printing the image. The image is printed based on the print information when the instruction is received.

### BACKGROUND OF THE INVENTION

The present invention relates to an apparatus and a method for printing an image.

In recent years, printing apparatuses have been spreading that can easily print images captured by a digital camera or the like. Recently, with the spread of digital cameras, printing apparatuses provided with a slot into which a memory card can be inserted or printing apparatuses provided with an interface for connection to a digital camera are commercially available. In such printing apparatuses, their print engines are of an ink jet type or sublimation type, and achieve high resolution printing.

Meanwhile, in the images captured by a digital camera, for example, the exposure value can be inappropriate or alternatively color fogging occurs owing to the camera's own characteristics or the like. Thus, techniques for correcting these have been proposed (see Japanese Patent Publication No. 2000-165647A, for example).

Meanwhile, when the correction described above is performed, first, sampling is performed on the image data at a predetermined ratio so that histograms are prepared. Next, correction parameters are determined on the basis of the prepared histograms. Finally, print processing is executed while performing correction processing on the image data by using the correction parameters. Thus, after the time that image data was specified and then a printing request was issued, the above-mentioned three processing steps need to be executed before the time that printing is actually performed. This causes the problem of a long waiting time before printing.

Further, in some cases, the image needs to be printed in a rotated orientation by a predetermined angle. In this case, this processing of rotating the image needs to be further executed in addition to the above-mentioned processing steps. This causes the problem of a much longer waiting time before printing.

### SUMMARY OF THE INVENTION

It is therefore an object of the present invention is to provide an apparatus and a method for printing an image, in which waiting time between the instruction of printing and the execution of printing can be reduced.

In order to achieve the above object, according to the invention, there is provided a printing method, comprising:

specifying a coded image data to be printed;

decoding the coded image data to generate a preview image;

displaying the preview image;

generating print information to be required to print an image corresponding to the preview image without an instruction for printing the image; and

printing the image based on the print information when the instruction is received.

The printing method may further comprise:

sampling pixels from an original image which is obtained by the decoding to generate sampling data serving as the print information;

calculate a correction parameter with reference to the sampling data when the instruction is received; and

correcting the original image based on the correction parameter.

The printing method may further comprise:

sampling pixels from an original image which is obtained by the decoding to generate sampling data;

calculate a correction parameter serving as the print information with reference to the sampling data when the instruction is received; and

correcting the original image based on the correction parameter.

The printing method may further comprise:

generating restoring information during the decoding, the restoration information adapted to restore a part of an original image to which processing is first applied, in a case where the image is obtained by rotating the original image; and

obtaining the original image by the decoding; and

rotating the original image to obtain the image based on the restoring information when the instruction is received.

The printing method may further comprise displaying a thumbnail image corresponding to the coded image data, the thumbnail image being adapted to be specified to specify the coded image data.

The printing method may further comprise:

terminating the decoding in a case where another coded image data is specified during the decoding; and

decoding the another coded image data to generate the preview image.

The printing method may further comprise:

dividing the coded image date into a plurality of data pieces each of which corresponds to a part of the image;

decoding one of the data pieces to obtain a decoded data piece corresponding to a part of the preview image;

displaying the part of the preview image; and

repeating the decoding of one of the data pieces and displaying the part of the preview image until the preview image is completed.

The printing method may further comprise reusing the print information in a case where the coded image data is again specified.

The printing method may further comprise storing the print information in a storage.

According to the invention, there is also provided a program product comprising a program adapted to cause a computer to execute the above printing method.

According to the invention, there is also provided a printing apparatus, comprising:

a specifier, operable to specify a coded image data to be printed;

a decoder, operable to decode the coded image data to generate a preview image, when the coded image data is specified;

a display, operable to display the preview image;

a generator, operable to generate print information to be required to print an image corresponding to the preview image without an instruction for printing the image; and

a print executer, operable to print the image based on the print information when the instruction is received.

### BRIEF DESCRIPTION OF THE DRAWINGS

The above objects and advantages of the present invention will become more apparent by describing in detail preferred exemplary embodiments thereof with reference to the accompanying drawings, wherein;

FIG. 1 is a perspective view of a printing apparatus according to a first embodiment of the invention;

FIG. 2 is a block diagram showing a control system of the printing apparatus of FIG. 1;

FIG. 3 is a flowchart showing the processing performed in the printing apparatus of FIG. 1;

FIG. 4 is a diagram showing the configuration of an image file used in the processing of FIG. 3;

FIG. 5 is a diagram showing thumbnail images displayed on an LCD in the printing apparatus of FIG. 1;

FIG. 6 is a diagram showing division of image data executed in the processing of FIG. 3;

FIG. 7 is a diagram showing an image displayed on the LCD, showing a case where the first one of divided image data is subjected to JPEG decoding shown in FIG. 3;

FIG. 8 is a diagram showing an image displayed on the LCD, showing a case where the second one of divided image data is subjected to JPEG decoding shown in FIG. 3;

FIG. 9 is a diagram showing an image displayed on the LCD, showing a case where the fourth one of divided image data is subjected to JPEG decoding shown in FIG. 3;

FIG. 10 is a diagram showing a histogram obtained by statistical processing shown in FIG. 3;

FIG. 11 is a diagram showing a histogram obtained by correction processing shown in FIG. 3;

FIG. 12 is a perspective view of a printing apparatus according to a second embodiment of the invention;

FIG. 13 is a block diagram showing a control system of the printing apparatus of FIG. 12;

FIG. 14 is a diagram showing a table for establishing correspondence between an image file and a sampling file, which is referred in processing according to a third embodiment of the invention;

FIG. 15 is a flowchart showing processing according to a fourth embodiment of the invention, which is executed as the JPEG decoding processing of step S14 of FIG. 3 when an image is to be printed in a rotated orientation;

FIG. 16 is a diagram for explaining an initial block used in the processing of FIG. 15;

FIG. 17 is a diagram for explaining an access unit used in the processing of FIG. 15;

FIG. 18 is a diagram for explaining decompression intermediate information used in the processing of FIG. 15;

FIG. 19 is a diagram showing initial point restoring information obtained by the processing of FIG. 15;

FIG. 20 is a diagram showing updated initial point restoring information used in the processing of FIG. 21;

FIG. 21 is a flowchart showing processing according to the fourth embodiment of the invention, which is executed as the JPEG decoding processing of step S24 of FIG. 3 when an image is to be printed in a rotated orientation;

FIG. 22 is a diagram showing a situation that the processing of steps S60-S68 of FIG. 21 is executed repeatedly; and

FIG. 23 is a diagram for explaining a unit band used in the processing of FIG. 21.

### DETAILED DESCRIPTION OF THE EMBODIMENTS

Embodiments of the present invention will be described below with reference to the accompanying drawings.

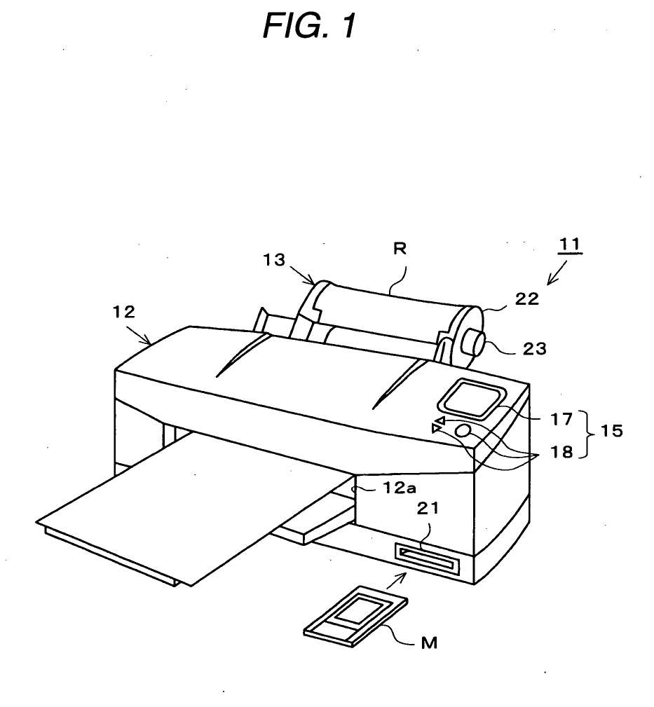

As shown in FIG. 1, an ink jet type printing apparatus 11 according to a first embodiment of the invention comprises: a casing 12; a sheet feeding unit 13 for feeding rolled sheet R and a cut sheet (not shown); and a printing section for performing printing onto the rolled sheet R or the cut sheet.

The box-shaped casing 12 has a control panel 15 at a right side of the upper face. The control panel 15 is equipped with: an LCD (Liquid Crystal Display) 17; and input buttons 18. The LCD 17 displays the menu function, the contents of operation, the status of operation, the contents of error, and the like of the printing apparatus 11. The input button 18 is pushed when menu selection or the like is performed in the printing apparatus 11. Further, using the LCD 17 and the input buttons 18 described here, various kinds of operations can be performed like cutting position adjustment.

The casing 12 has an ejection port 12a at a lower part of the front face so that rolled sheet R or a cut sheet having undergone printing is ejected through this port. Further, a card slot 21 is provided at a front right side of the casing 12, while, for example, a memory card M for recording image data captured by a digital camera or the like is accommodated in this slot in a freely removable manner.

The sheet feeding unit 13 is provided at the rear face side of the casing 12, and has a holder 22 fixed to the casing 12 and a rotary shaft 23. Then, the termination end of the rolled sheet R is connected to and wound around the rotary shaft 23. In this state, the rotary shaft 23 is rotatably supported on the holder 22. Then, when a user pinches both ends of the rotary shaft 23 and then rotates the rotary shaft 23 in a normal or reverse direction, the rolled sheet R is fed forward from or rolled up to the sheet feeding unit 13.

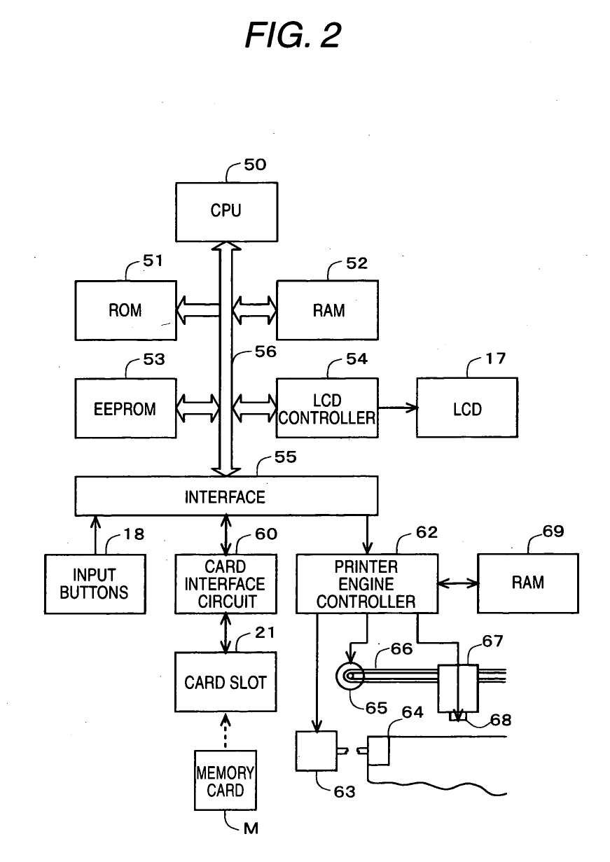

As shown in FIG. 2, a control system of the printing apparatus includes a CPU (Central Processing Unit) 50, a ROM (Read Only Memory) 51, a RAM (Random Access Memory) 52, an EEPROM (Electrically Erasable and Programmable ROM) 53, an LCD controller 54, an interface 55, a bus 56, the LCD 17, the input buttons 18, the card slot 21, a card interface circuit 60, a printer engine controller 62, a sheet feeding motor 63, a sheet feeding roller 64, a carriage motor 65, a driving belt 66, a carriage 67, a printing head 68, and a RAM 69.

Here, the CPU 50 executes various kinds of arithmetic processing according to programs stored in the ROM 51 and the EEPROM 53 and at the same time, controls various sections of the apparatus including the sheet feeding motor 63 and the carriage motor 65.

The ROM 51 is a semiconductor memory for storing various kinds of programs executed by the CPU 50 and various kinds of data. The RAM 52 is a semiconductor memory for temporarily storing programs and data to be executed by the CPU 50.

The EEPROM 53 is a semiconductor memory for storing predetermined data such as arithmetic processing results of the CPU 50 and thereby holding the data even after the printing apparatus is deactivated.

The LCD controller 54 executes display processing on the basis of a display command provided from the CPU 50, and then provides and displays the obtained image data on the LCD 17.

The interface 55 is a unit for appropriately converting the form of representation of the data when information is transferred between the input buttons 18, the card interface circuit 60, and the printer engine controller 62.

The bus 56 is signal lines for interconnecting the CPU 50, the ROM 51, the RAM 52, the EEPROM 53, the LCD controller 54, and the interface 55, and thereby realizing the transfer of information between these units.

As described above, the input button 18 is operated when menu selection or the like is performed. As described above, the memory card M is a non-volatile memory for storing image data captured by a digital camera.

As described above, the card slot 21 is provided at a front right side of the casing 12 of the printing apparatus 11, while the memory card M is inserted into this portion. The card interface circuit 60 is an interface for writing or reading information to or from the memory card M.

The printer engine controller 62 is a control unit for controlling the sheet feeding motor 63, the carriage motor 65, and the printing head 68. The sheet feeding motor 63 rotates the sheet feeding roller 64 and thereby moves the cut sheet or the rolled sheet R (referred collectively as a printing sheet) in the secondary scanning direction. The sheet feeding roller 64 is composed of a cylindrical member, and moves the cut sheet or the rolled sheet R in the secondary scanning direction.

The carriage motor 65 provides a driving force to the driving belt 66 one end of which is fixed to the carriage 67, and thereby realizes reciprocating motion of the carriage 67 in the primary scanning direction. The printing head 68 is provided with a plurality of nozzles formed in a face opposing the printing sheet, and thereby discharges ink from a plurality of the nozzles so as to record information onto the printing sheet.

The RAM 69 is a semiconductor memory into which the printer engine controller 62 temporarily stores image data to be printed.

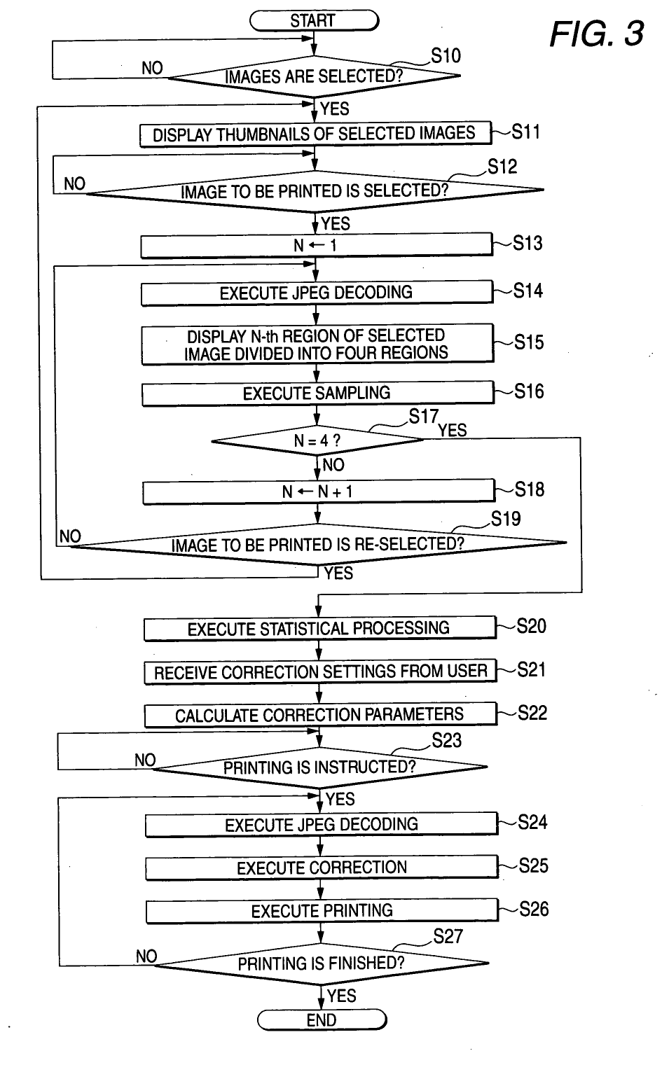

For example, when image data stored in a memory card M or a digital camera is to be printed in a case that the memory card M is inserted into the card slot 21 or alternatively that the digital camera (not shown) is connected to the interface 55 through a cable (not shown), the processing shown in FIG. 3 is started, the following steps are executed.

Step S10: The CPU 50 determines whether the input button 18 has been operated so that images to be printed has been selected. In the case of having been selected, the CPU 50 goes to step S11. Otherwise, the CPU 50 repeats the same processing. For example, when the input button 18 has been actuated so that predetermined image data stored in the memory card M has been specified as the printing object, the CPU 50 goes to step S11.

Step S11: The CPU 50 acquires thumbnail images contained in a file corresponding to the images selected at step S10, and then provides the thumbnail images to the LCD controller 54 so as to display the thumbnail images on the LCD 17.

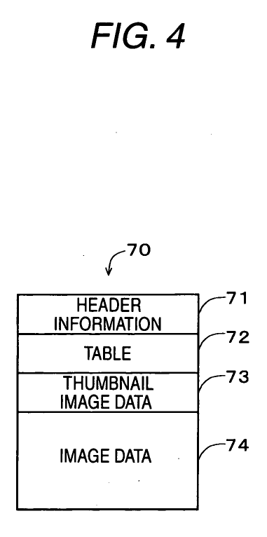

As shown in FIG. 4, the image file 70 is data in the form of EXIF (Exchangeable Image File Format) or the like, and composed of header information 71, a table 72, thumbnail image data 73, and image data 74. For example, the header information 71 includes the filename, the compression method, the image size, the density unit, the information of image capturing conditions (the exposure time, the use or non-use of a flash), and the information such as the manufacture name and the model name of the employed digital camera. The table 72 is composed, for example, of a quantization table, an entropy coding table, and the like. The thumbnail image data 73 is the data of thumbnail images serving as reduced size images of the image data 74. The image data 74 is composed of image data compressed by the JPEG (Joint Photographic Coding Experts Group) method.

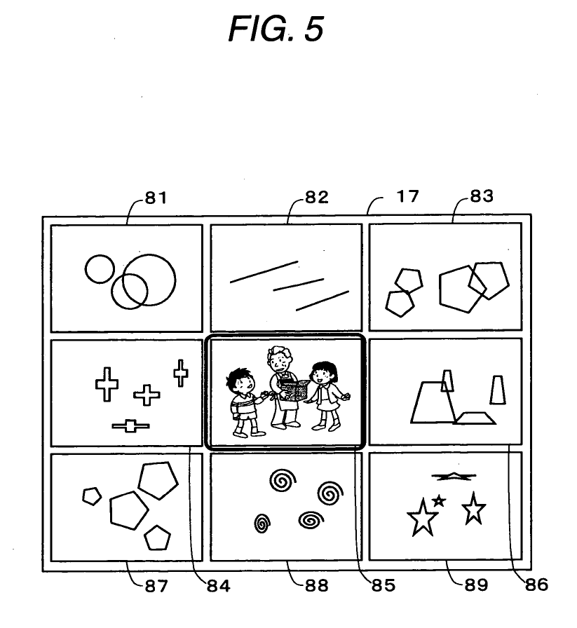

The CPU 50 identifies in the memory card M an image file corresponding to the images selected at step 810, then acquires thumbnail image data contained in the identified image file, and then provides the data to the LCD controller 54 so as to display the images. As a result, information as shown in FIG. 5 is displayed on the LCD 17. In this example, nine thumbnail images 81-89 are displayed on the LCD 17.

Step S12: The CPU 50 determines whether the input button 18 has been actuated so that a predetermined thumbnail image has been selected from the thumbnail images displayed at step S11. In the case of having been selected, the CPU 50 goes to step S13. Otherwise, the CPU 50 repeats the same processing. For example, when the input button 18 is operated, a “frame” surrounding a thumbnail image moves in an arbitrary direction as shown in FIG. 5, so that an image to be printed is selected.

Step S13: The CPU 50 initializes into “1” a variable N for counting the number of times of processing.

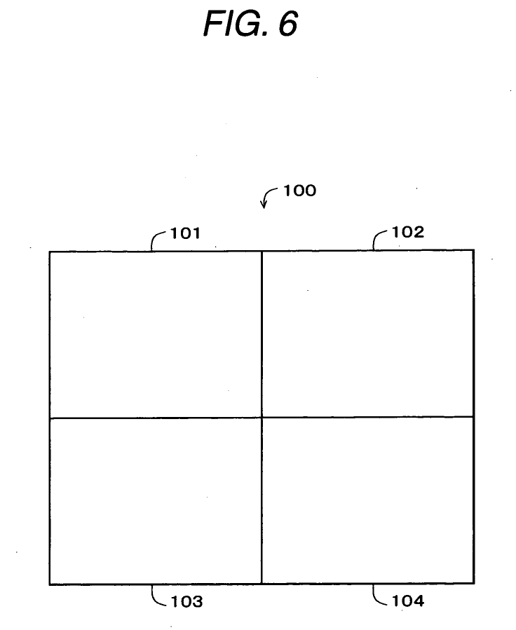

Step S14: The CPU 50 executes the processing of JPEG-decoding with respect to N-th one of the image data having been selected at step S12 and then divided into four. Specifically, when the image data 100 is selected as the printing object as shown in FIG. 6, the CPU 50 acquires an entropy coding table from the table 72 of the image file 70 as shown in FIG. 4, and then decodes the DC coefficients and the AC coefficients of the Y (brightness component), the Cr (color difference component) and the Cb (color difference component) in each block contained in the image data 74 corresponding to the four regions 101-104. At this time, the decoding is performed by the unit of MCU which is the minimum coding unit. Further, the order of decoding is, for example, performed sequentially from the region 101 to the region 104.

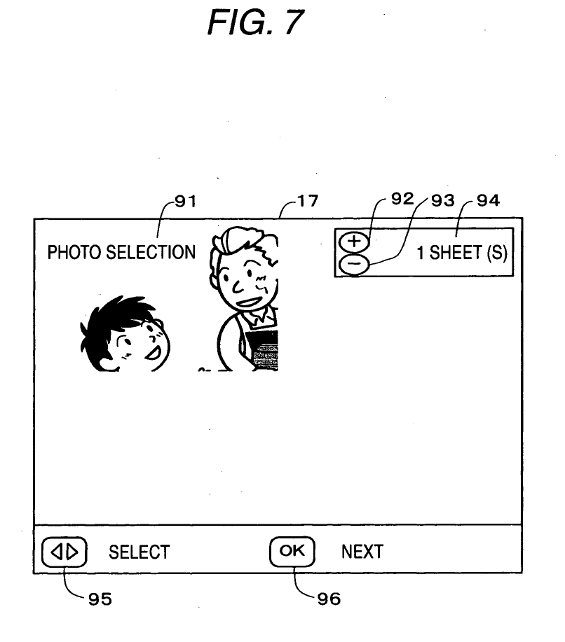

Step S15: The image data of the N-th region decoded at step S14 is converted into that in the RGB color coordinate system, and then displayed on the LCD 17. For example, when N=1, an image as shown in FIG. 7 is displayed. In this example, the upper left region of the image corresponding to the thumbnail image 85 selected in FIG. 5 is displayed on the LCD 17. Further, input buttons 92 and 93 for setting up the number of copies and this selected number of copies 94 are displayed at the upper right of the LCD 17. Further, an input button 95 to be operated for the purpose of selecting another image and an input button 96 to be operated for the purpose of performing print processing are displayed at the lower part of the LCD 17. Here, the size of the image displayed on the LCD 17 is, for example, of QVGA (Quarter Video Graphics Array), while the size of the original image is of VGA or larger. Thus, pixel skipping is performed depending on the size of the LCD 17.

Step S16: The CPU 50 executes the processing of sampling pixels at a predetermined ratio from the image data decoded at step S14. Specifically, pixels are sampled at a fixed ratio from any one of each component of the RGB color coordinate system, each component of the YCC color coordinate system, and the component of the HSB (Hue Saturation Brightness) color coordinate system or alternatively from a combination of these. Here, the HSB component is obtained by calculation based on the RGB component or the YCC component. Further, the sampling ratio is set up, for example, such that the size of the image data having undergone the pixel skipping should become QVGA as described above. The data obtained by the sampling is stored into the RAM 52.

Step S17: The CPU 50 determines whether the value of the variable N for counting the number of times of processing is “4” (that is, whether the decoding processing has been completed for all the regions of the image). In the case of true, the CPU 50 goes to step S20. Otherwise, the CPU 50 goes to step S18.

Step S18: The CPU 50 increments by “1” the value of the variable N.

Step S19: The CPU 50 determines whether an operation of re-selecting an image to be printed has been performed. For example, when the input button 95 (corresponding to a predetermined input button in the input button 18) has been operated so that instruction of selecting another image has been performed, the CPU 50 returns to step S11 and then repeats the same processing.

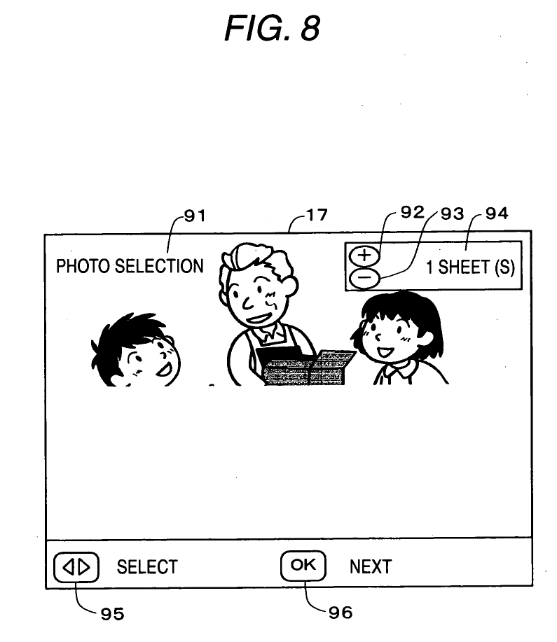

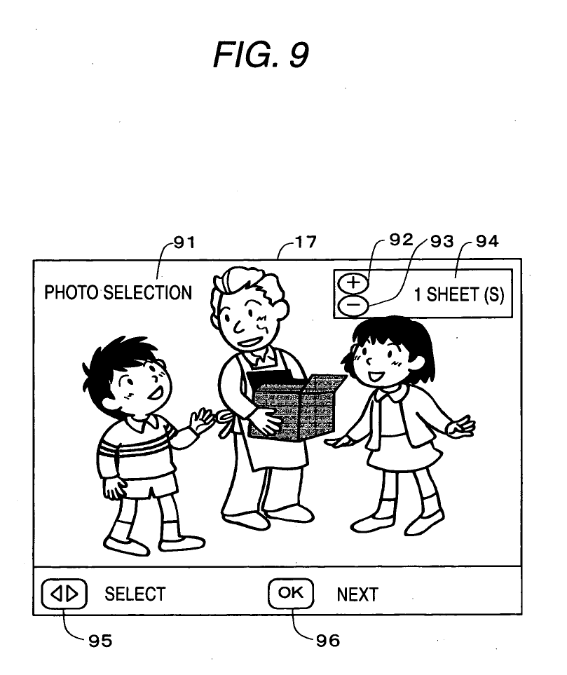

Here, when an operation of reselecting an image to be printed has not been performed, the four regions constituting the image data are decoded sequentially, and then displayed on the LCD 17 sequentially. For example, after the state shown in FIG. 7, when the second region is displayed, the state of FIG. 8 is realized. Then, the third region is displayed. After that, when the fourth region is displayed, the state of FIG. 9 is realized. As such, the image is displayed quarter by quarter.

This is because if display were performed after the completion of the entire decoding, it would take a long time before the display. The display may be performed ⅛ by ⅛ in place of quarter by quarter. Additionally, another ratio may be employed. Further, in place of dividing into a grid shape, the dividing may be performed in a horizontally elongated strip shape. Then, decoding and displaying may be performed sequentially starting at the top one. Further, in place of dividing, the entire image may be displayed as a whole. In this case, when display is performed in a progressive method, a sequential method, or the like, the degree of advance of decoding processing can be referred to. This allows the user to recognize the advance of the processing.

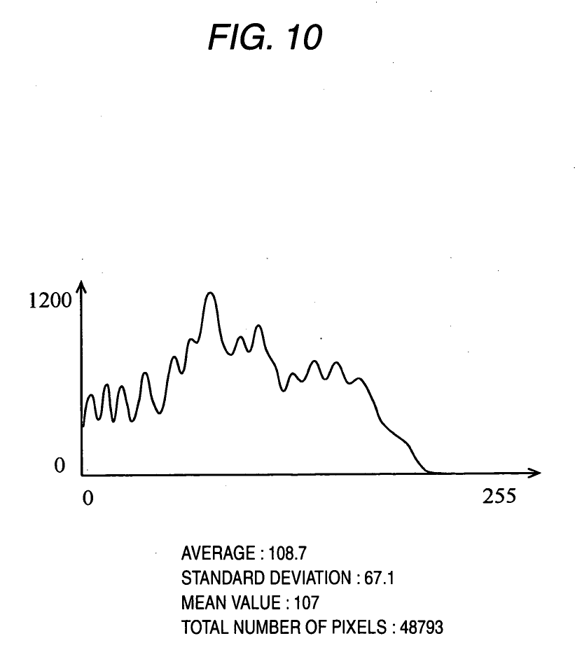

Step S20: The CPU 50 performs statistical processing on the pixels sampled at step S16, and thereby obtains histograms. FIG. 10 shows an example of a histogram obtained by the processing of step S20. This example shows, for example, a histogram of the Y component in the YCC color coordinate system. The horizontal axis of this figure indicates the value of the Y component, while the vertical axis indicates the number of pixels. Further, in this example, the average is “108.7,” the standard deviation is “67.1,” the mean value is “107,” and the total number of pixels is “48793.” Further, a histogram is obtained also for each component of each of the color coordinate systems other than this (the RGB color coordinate system and the HSB color coordinate system).

Step S21: The CPU 50 executes setting processing for receiving the setting of the contents of correction performed by the user. That is, the CPU 50 displays a GUI (Graphical User Interface) used for setting the contents of correction on the LCD 17, thereby allows the user to input the contents of correction, and then sets up details of correction processing on the basis of the inputted contents. More specifically, the CPU 50 (1) selects whether the correction processing should be performed automatically or performed by manual setting, then (2) sets up the brightness, the contrast, the sharpness, and the saturation, and then (3) displays a GUI used for selecting any one of color printing, sepia printing, and monochrome printing and then receives a specification from the user.

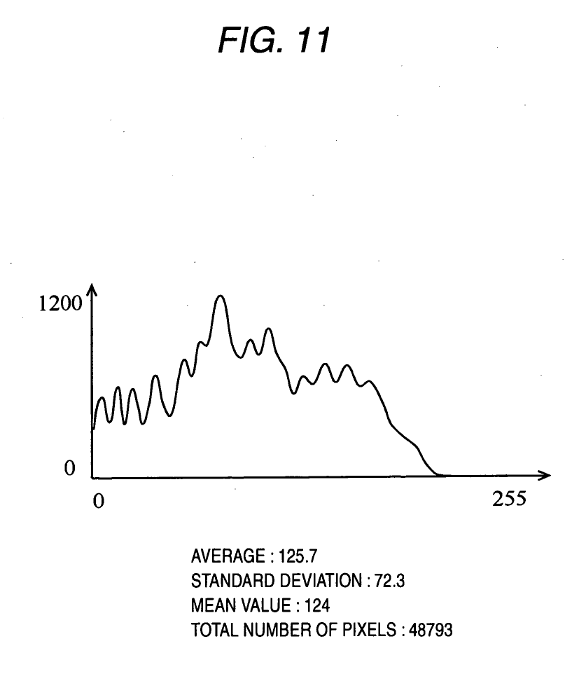

Step S22: Referring to the statistical values obtained at step S20, the setting values inputted at step S21, and the information indicating the image capturing conditions which is additional information and the like of EXIF or PIM (Print Image Matching) accompanied in the image file, the CPU 50 calculates correction parameters. For example, in the example of FIG. 10, the distribution is biased toward the lower Y component value. Thus, parameters are calculated such as to realize a balanced distribution with respect to the mean value adopted as the center as shown in FIG. 11. Specifically, for example, when the maximum value of the Y component in FIG. 10 is denoted by Y0, a correction value C is selected as C=255/Y0. Then, each pixel value is multiplied by the correction value C, so that the distribution range of the pixel values spreads between 0-255. At that time, the contents of the user's setting at step S21 is also taken into consideration. Other parameters similar to this are, for example: a correction parameter for each component of R, G, and B in the RGB color coordinate system; and a correction parameter for each component of H, S, and B in the HSB color coordinate system. Specifically, in the RGB color coordinate system, for example, correction parameters are used for adjusting the balance of the R, G, and B components in order to cancel color fogging. For example, when red is excessively intense, the R component is multiplied by a predetermined correction value smaller than 1. By virtue of this, the balance of the RGB is recovered so that color fogging is dissolved.

Step S23: The CPU 50 determines whether the input button 18 has been actuated so that printing instruction has been performed. In the case of having been performed, the CPU 50 goes to step S24. Otherwise, the CPU 50 repeats the same processing. Here, the phrase “printing instruction” indicates that after the printing conditions (such as the number of cut sheets) are set up, processing of generating print data is instructed to begin. More specifically, the phrase indicates that the user operates the input button 18 and thereby instructs the printing.

Step S24: The CPU 50 executes JPEG decoding processing of the specified image data. In the decoding, the image data is decoded by the unit band which is the printing width per one scan of the printing head 68.

Step S25: The CPU 50 executes the processing of correcting the image data by using the correction parameters obtained at step S22. Specifically, the correction parameters calculated at step S22 are applied onto each pixel. By virtue of this, for example, color fogging is canceled, exposure is corrected appropriately, color balance is corrected appropriately, and contrast is corrected appropriately. For example, when red is excessively intense owing to color fogging, for example, the processing of multiplying each pixel value by a value of “0.9” is performed such that the distribution in the histogram of R should move toward the origin.

Step S26: The CPU 50 executes print processing. That is, the CPU 50 provides the image data of the unit band having undergone the correction processing, to the printer engine controller 62. As a result, ink of the corresponding color is ejected from the print head 68. Further, the carriage motor 65 performs scan in the primary scanning direction, while the sheet feeding motor 63 performs scan in the secondary scanning direction, so that an image is printed.

Step S27: The CPU 50 determines whether printing of all lines has been completed. In the case of not being completed, the CPU 50 returns to step S24 and then repeats the same processing. Otherwise, the CPU 50 terminates the processing.

With the above configurations, sampling is simultaneously performed while an image to be printed is displayed and previewed on the LCD 17. This reduces waiting time between the instruction of printing and the actual start of printing.

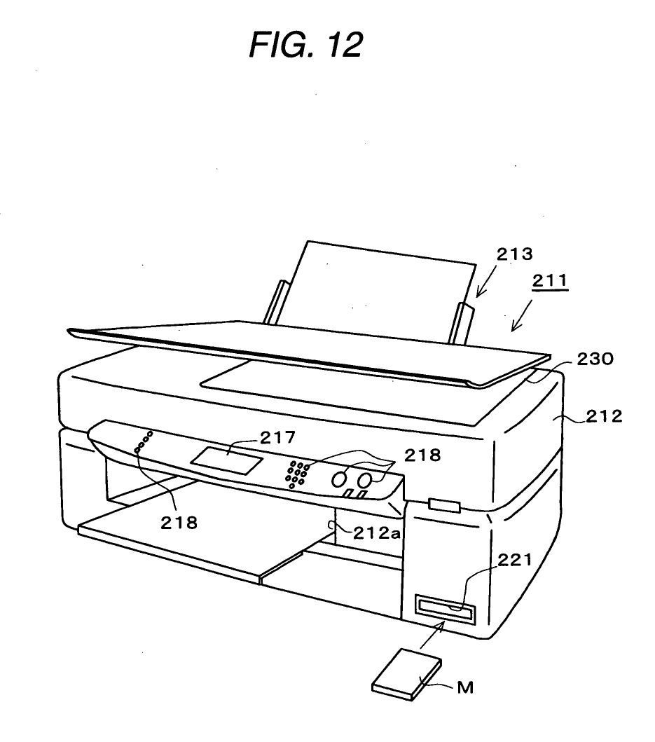

The first embodiment has been described by adopting a standalone type printing apparatus as an example. However, the present invention is applicable also to an ordinary printing apparatus (a printing apparatus of a type used in a state connected to a personal computer). Further, the present invention is applicable also to a so called hybrid type printing apparatus in which a scanner apparatus, a printing apparatus, and a copying apparatus are integrated as shown in FIG. 12. Such a hybrid type printing apparatus will be described as a second embodiment of the invention. Components similar to those in the first embodiment will be designated by the same reference numerals and repetitive explanations for those will be omitted.

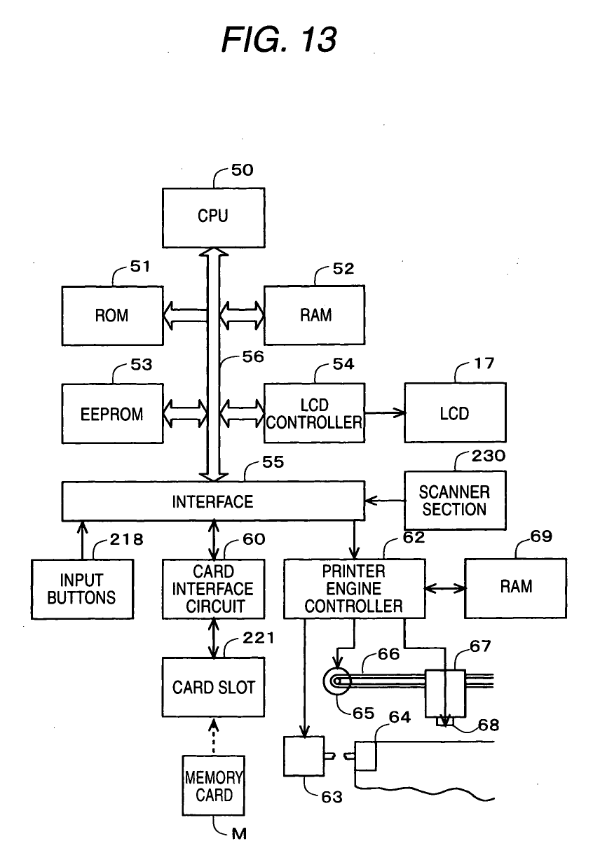

As shown in FIGS. 12 and 13, a hybrid type printing apparatus 211 is equipped with: a casing 212; a sheet feeding unit 213 for feeding a cut sheet; a scanner section 230 for reading an image printed on a sheet medium or the like; and a printing section (not shown) for performing printing onto the cut sheet.

The box-shaped casing 212 has the scanner section 230 at the upper part thereof. An LCD 217 and input buttons 218 for various kinds of operations are provided at a center part of the front face. Similar to the casing 12 of the first embodiment, the LCD 217 displays the menu function, the contents of operation, the status of operation, the contents of error, and the like of the printing apparatus 211. The input button 218 is pushed when menu selection or the like is performed in the printing apparatus 211.

The casing 212 has an ejection port 212a at a lower part of the front face, so that a printed cut sheet is ejected through this port. Further, a card slot 221 is provided at a front right side of the casing 212, while, for example, a memory card M for storing image data captured by a digital camera or the like is accommodated in this slot in a freely removable manner.

The sheet feeding unit 213 is provided at the rear side of the casing 212, and stocks cut sheets so as to feed one sheet at a time into the printing apparatus 211 in a case of being necessary.

The input buttons 218 include buttons for controlling the scanner function and the copying function. The scanner section 230 is composed of: an optical system and an imaging system for reading an image printed on a sheet medium; and a controller for controlling these systems. Then, under the control of the CPU 50, the scanner section 230 reads the image printed on the sheet medium, then converts the image into corresponding image data, and then outputs the data.

In this hybrid type printing apparatus 211, when the above-mentioned processing is performed on image data read from the memory card M or alternatively image data read from the digital camera, waiting time can be reduced between the instruction of printing and the actual start of printing.

Next, a third embodiment of the invention will be described. Components similar to those in the first embodiment will be designated by the same reference numerals and repetitive explanations for those will be omitted.

In the first and second embodiments, when an image to be printed is selected at step S12, sampling processing is performed during the preview processing, so that correction parameters are calculated. However, sampling need not be performed at each time when the preview processing is performed. In this embodiment, sampling data obtained as a result of sampling processing may be saved as a file. Then, when the same image is selected again, the parameters may be calculated using the file. That is, in the processing of FIG. 3, after the processing of step S16 or alternatively after the processing of step S17, the sampling data may be saved as a file into the RAM 52 or the memory card M, while a table may be prepared for establishing correspondence between the file and the image file. Then, when the image is selected again at step S12, the table is referred to. If the sampling file is available, sampling processing shown in step S16 may be omitted.

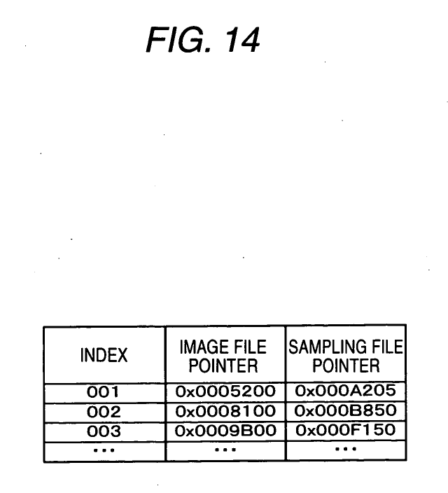

FIG. 14 shows an example of the table for establishing correspondence between the image file and the sampling file. In this example, the table includes: indices each for identifying an image file stored in the memory card M; image file pointers each for indicating the physical location on the memory card M for the image file; and sampling file pointers each for indicating the physical location on the RAM 52 for the sampling data file prepared from the image file. Among these information items, as for the indices and the image file pointers, at the time of activation the printing apparatus 11 or alternatively at the time of installing the memory card M, indices are assigned to all image files stored in the memory card M or the like, while image file pointers are acquired and registered for all of them.

At the time of activation the printing apparatus 11 or alternatively at the time of installing the memory card M, an empty value (Null value) is set up into the sampling file pointers. This is because the information of the table is cleared at the time of activation the printing apparatus 11 or alternatively at the time of installing the memory card M. Thus, when the first image file is printed after the time of activation the printing apparatus 11 or alternatively after the time of installing the memory card M, no sampling file pointer is present for any image file. Here, in the table, the “index” column may be omitted.

After this table is generated, when printing of an image file is instructed, the table is referred to so that it is determined whether the sampling file pointer is Null. In the case of Null, it is determined that no sampling file is present, so that sampling processing is executed at the time of preview. Then, the obtained sampling data is stored into the RAM 52 or the memory card M as a sampling file. Then, the pointer of the file is acquired and then stored into the sampling pointer field of the table. On the other hand, in the case of not being Null, it is determined that a sampling file is present, so that sampling processing is not executed at the time of preview. After that, in the processing of step S20, statistical processing is executed on the corresponding sampling file. Then, on the basis of the acquired values, correction processing is executed.

With the above configurations, the sampling file is saved, so that when the same image file is to be printed again, the corresponding sampling file is used. Thus, when the same image is to be printed again, sampling processing is omitted so that the entire processing can be accelerated.

Here, in this embodiment, the sampling data is saved as a file. However, for example, at least one of the statistical values calculated at step S20, the setting values inputted at step S21, and the parameters calculated at step S22 may be saved. Then, when printing of the same image file is instructed again, correction processing may be executed using these values. In such a case, when the same image is to be printed again, the processing of steps S20-S22 is omitted so that the entire processing is accelerated.

The sampling data, the statistical values, and the correction parameters are larger concerning the amount of data in this order. Thus, from the viewpoint of reducing the required memory capacity it is preferable to save the correction parameters. Nevertheless, the correction parameters vary depending on the contents of the user's setting received at step S21. Thus, when the contents of the setting are changed, the correction parameters need to be calculated again. Thus, the statistical values, the setting value, and the parameters may be saved so that when the same image is printed, printing may be performed on the basis of the same parameters in the case that the setting values are not changed. In contrast, in the case that the setting values are changed, the parameters may be calculated again from the statistical values. According to this method, even when the contents of the setting are changed, decoding processing for the image file need not be executed again. Thus, even when the contents of the setting are changed, the waiting time before the printing can be reduced.

Further, in addition to the sampling file for correction processing, an image file used for preview display on the LCD 17 (referred to as a “preview image file,” hereinafter) may be saved in a manner corresponding to the table shown in FIG. 14. Then, when the same image file is selected, the saved preview image file may be displayed on the LCD 17.

Next, a fourth embodiment of the invention will be described. Components similar to those in the first embodiment will be designated by the same reference numerals and repetitive explanations for those will be omitted.

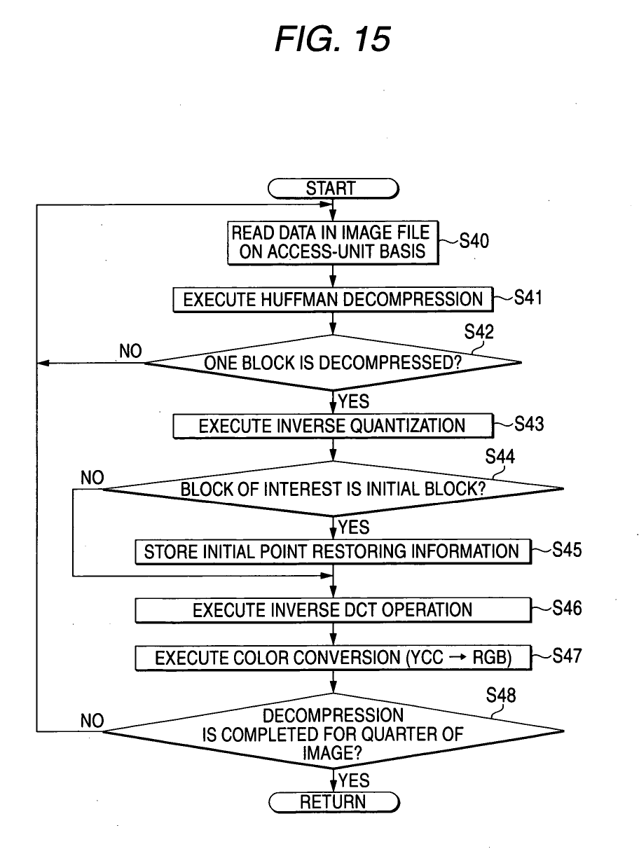

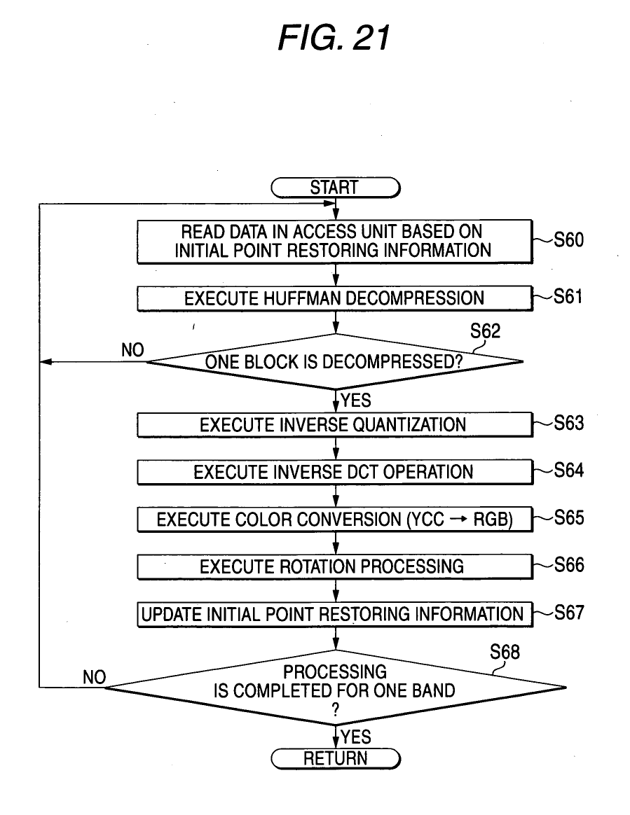

In the above-mentioned embodiments, print processing is performed without applying rotation processing with respect to the image file (rotating an image to be printed). However, the processing shown in FIGS. 15 and 21 may be executed, respectively, at steps S14 and S24 shown in FIG. 3, so that the image can be printed in a rotated orientation at a desired angle.

That is, when an image is to be printed in a rotated orientation, at the time of preview display, initial point restoring information (described later in detail) used for rotating the image may be generated and stored into the RAM 52. Then, in the printing, by referring to the initial point restoring information, the image may be printed in a rotated orientation. This reduces the processing for rotating the image, and hence reduces the waiting time before the printing. Details of this processing will be described below

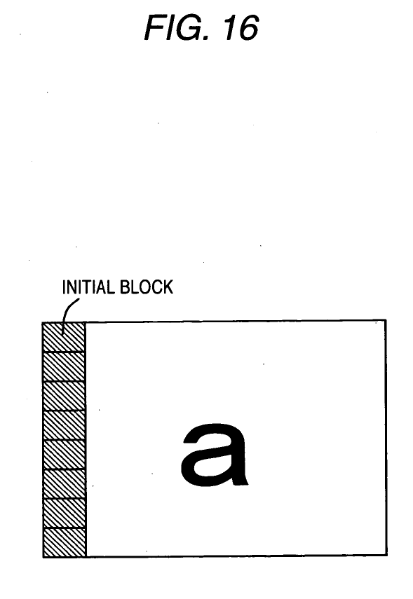

FIG. 15 shows processing executed as “JPEG decoding processing” of step S14 of FIG. 3 when an image is to be printed in a rotated orientation. This is processing of decoding an image file and then generating initial point restoring information used for printing the image file in a rotated orientation. Here, the initial point restoring information is information used for restoring an image file halfway from an initial block serving as an initial point. Specifically, for example, when the image shown in FIG. 16 is to be printed in an orientation rotated rightward by 90 degrees, the left end block which will go to the top is adopted as the initial block. When the flowchart shown in FIG. 15 is started, the following steps are executed.

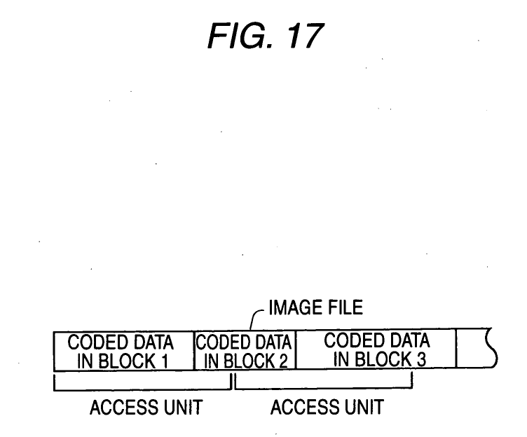

Step S40: The CPU 50 reads data of one access unit of the image file selected at step S12, from the memory card M or the like. Here, the access unit indicates the unit of data reading in defined in advance according to the specification of the memory card M or the like, and corresponds, for example, to the sector in a flash memory or the like. As shown in FIG. 17, the data size of each block of the image file compressed by the JPEG method does not necessarily agree with the access unit. Further, the data size varies depending on each block. Thus, the data of one block spreads to a plurality of access units in some cases.

Step S41: The CPU 50 executes the processing of performing Huffman decompression on the image data of one access unit read at step S40.

Step S42: The CPU 50 determines whether Huffman decompression of the data of one block shown in FIG. 17 has been completed. In the case of not having been completed, the CPU 50 returns to step 540 and then repeats the same processing. When decompression for the one block has been completed, the CPU 50 goes to step S43.

Step S43: The CPU 50 performs inverse quantization on the data of one block (the quantized DCT coefficients of the block) decompressed by the processing of Steps S40-42. As a result, the DCT coefficients of the block are acquired. Here, in the image file compressed by the JPEG method, as for the quantized DC components of the quantized DCT coefficients, difference values between blocks are Huffman-coded. Thus, when the difference values of the quantized DC components obtained by Huffman decompression are accumulated, quantized DC components are acquired. Then, when inverse quantization is performed on the quantized DC components, the DC components are acquired.

Step S44: The CPU 50 determines whether the block is the initial block. In the case of being the initial block, the CPU 50 goes to step S45. Otherwise, the CPU 50 goes to step S46. In this embodiment, the image is assumed to be rotated rightward by 90 degrees. Thus, the initial block is the left end block which goes to the top when the image is rotated rightward by 90 degrees.

Step S45: The CPU 50 generates initial point restoring information, and then stores the information into a predetermined region of the RAM 52. Specifically, the initial point restoring information is composed of a file pointer for indicating the physical location of the access unit where the data of the initial block begins; decompression intermediate information used for beginning Huffman decompression with respect to the data in the indicated access unit; and the DC components of the initial block.

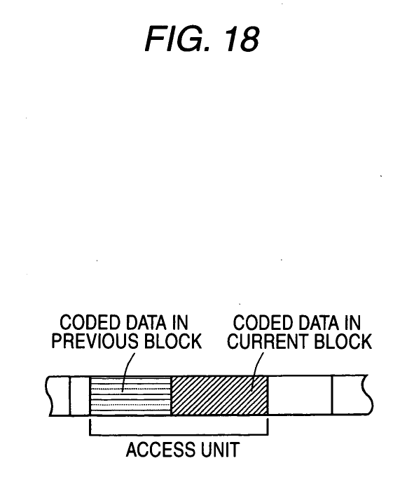

FIG. 18 is a diagram conceptually describing the decompression intermediate information. As described above, the data size and the access unit of each block do not necessarily agree with each other. Further, the data size varies depending on each block. Thus, the access unit in which the data of the initial block begins can also contain the data of the previous block. Thus, in the Huffman decompression of the data of the initial block, information concerning the Huffman decompression of the data of the previous block is necessary (e.g., the number of bits of the data portion of the previous block where the Huffman decompression has been performed). Such information corresponds to the decompression intermediate information.

Step S46: The CPU 50 performs inverse DCT operation on the data of one block having undergone inverse quantization at step S43, and thereby acquires pixel information of the block.

Step S47: The CPU 50 performs color conversion on the image information of the block obtained at step S46. Here, the color conversion is the processing of converting into the data of the RGB color space the data of the YCC color space used in the image file of the JPET method.

Step S48; The CPU 50 determines whether decompression processing of a quarter region of the image has been completed. In the case of having been completed, the CPU 50 returns to the processing of step S15. Otherwise, the CPU 50 returns to step S54 and then repeats the same processing.

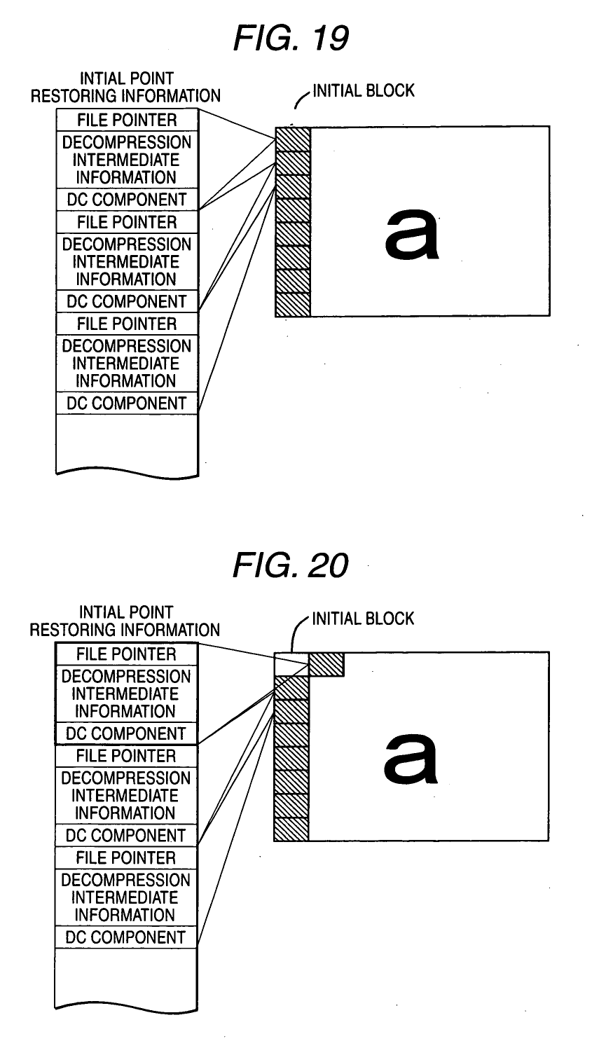

FIG. 19 is a diagram showing an example of initial point restoring information obtained when the above-mentioned processing is executed repeatedly. In this example, the left end blocks of the image are set as the initial block. Thus, initial point restoring information (the file pointer, the decompression intermediate information, and the DC components) for each left end block is stored sequentially from the top block.

According to the above-mentioned processing, at the time that the image file selected at step S12 is displayed and previewed on the LCD 17, the above-mentioned initial point restoring information used for performing rotation processing of the image can be generated.

There will be described the processing executed as “JPEG decoding processing” of step S24 of FIG. 3 when an image is to be printed in a rotated orientation. This is processing of decoding an image file and referring to the initial point restoring information so as to decoding the image file in a rotated orientation. When the flowchart shown in FIG. 21 is started, the following steps are executed.

Step S60: The CPU 50 reads the file pointer of the first initial block among the initial point restoring information stored in the RAM 52. Then, the CPU 50 reads from the memory card M or the like the date of one access unit identified by the read file pointer, and then performs Huffman decompression. At this time, by virtue of the decompression intermediate information in the initial point restoring information, the CPU 50 can acquire and decompress the data of the initial block among the data of the one access unit.

Step S61: The CPU 50 performs Huffman decompression on the data read at step S60.

Step S62: The CPU 50 determines whether decompression processing for the one block has been completed. When decompression of the one block has been completed, the CPU 50 goes to step S63. Otherwise, the CPU 50 returns to step S60, and then repeats the same processing until the processing for the one block is completed.

Step S63: The CPU 50 executes inverse quantization on the decompressed data of one block. As a result, DCT coefficients of the block are acquired.

Step S64: The CPU 50 performs inverse DCT operation on the data of one block having undergone inverse quantization at step S63, and thereby acquires pixel information of the block. At this time, the DC components of the initial point restoring information are read, thereby acquiring the DC components of the DCT coefficients.

Step S65: The CPU 50 performs color conversion on the image information of the block obtained at step S64. Here, as described above, the color conversion is the processing of converting the data of the YCC color space into the data of the RGB color space.

Step S66: The CPU 50 rotates rightward by 90 degrees the block data having undergone color conversion in the processing of step S65, and then stores the data Into a predetermined region of the RAM 52.

Step S67: The CPU 50 updates the initial point restoring information of the block having undergone the rotation processing performed at step S66, into the initial point restoring information of the next block (right adjacent block). That is, as shown in FIG. 20, update is performed into the file pointer, the decompression intermediate information, and the DC components of the one access unit where the data of the next block begins. As for the DC components described here, the quantized DC components of the current block are adopted and stored. When the next block is to be restored, the difference value between each quantized DC component and each value obtained by Huffman decompression on the data of the next block is accumulated so that quantized DC components of the next block can be acquired.

Step S68: The CPU 50 determines whether processing for the one band has been completed. When decompression processing for the one band has been completed, the CPU 50 returns to the processing of step S25. Otherwise, the CPU 60 returns to step 560 and then repeats the same processing. Here, the band indicates the unit of printing executed by the printer engine controller 62.

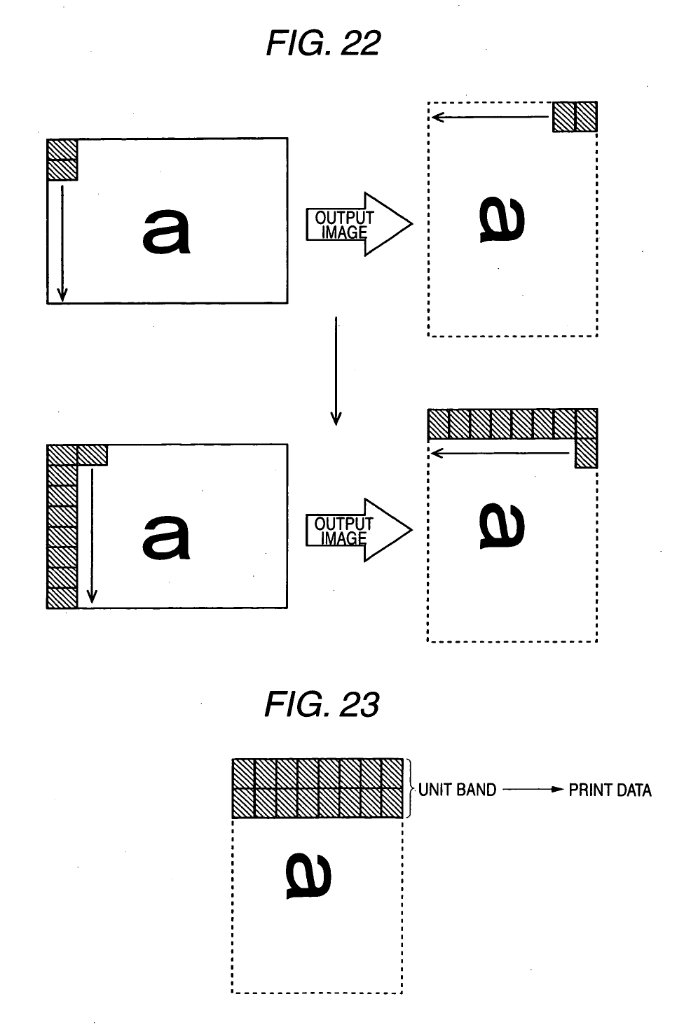

As shown in FIG. 22, when the processing of steps S60-S68 is executed for the left end blocks serving as the initial block, sequentially starting from the top block, the top two blocks of the rotated image are outputted. Then, when the processing for the left end blocks has been completed, the processing of steps S60-S68 is repeated and executed for the blocks of the column at the right adjacent of the left end blocks sequentially starting from the top block. Then, as shown in FIG. 23, when the rotated and accumulated blocks constitute one band, the correction processing of step S25 is performed on this data of one unit band. Then, print data is generated at step S26, and then the printer engine controller 62 executes print processing. Then, when the processing reaches the last block of the image file, the print processing is terminated.

With the above configurations, at the time that the processing of preview display of the image is executed on the LCD 17, sampling for correction processing is performed, while initial point restoring information is generated simultaneously. Then, when printing of the image is instructed, correction processing is executed at the same time as the image is rotated by referring to the initial point restoring information. This reduces waiting time between the instruction of printing and the start of printing. In this embodiment, the initial point restoring information is generated at each time when the preview operation is performed. However, as for the image having undergone the preview operation, its initial point restoring information may be saved as a file (referred to as a “restoring information file,” hereinafter), while correspondence may be established between this information and the image file by using the table as shown in FIG. 14. Then, when preview of the same image is instructed, the corresponding restoring information file may be reused. By virtue of this, generation of the initial point restoring information can be omitted so that the entire processing can be accelerated.

Further, the index and the image file pointer may be combined appropriately with the pointer of the file of the data for correction (such as the file of sampling data and the file of the parameters), the pointer of the preview image file, and the pointer of the restoring information file, so that a table may be generated. Then, by referring to the table, the already prepared file may be reused. This reduces the time necessary for the preparation of a preview image, the preparation of correction parameters, and the preparation of initial point restoring information. This reduces further the waiting time between the instruction of printing and the actual start of printing.

In the above-mentioned embodiments, an image is divided into four regions, and then each region is decoded sequentially. However, dividing into regions may be performed into a number other than four. Additionally, in place of dividing into a grid shape, the dividing may be performed in a horizontally elongated strip shape. Then, decoding and displaying may be performed sequentially starting at the top one. Additionally, the above-mentioned dividing need not be performed, while decoding and displaying may be performed by a progressive method or a sequential method.

In the above-mentioned embodiments, thumbnail images are displayed so that an image to be printed is selected. However, in place of the thumbnail images, for example, the filenames of image files may be displayed and selected.

In the above-mentioned embodiments, at the time of completion of decoding of a quarter of the region, it is determined whether an image to be printed is re-selected. However, the presence or absence of re-selection may be detected also in the course of decoding. In this case, when an image to be printed is re-selected, the procedure can immediately go into the processing for the re-selected image.

In the above-mentioned embodiments, a single selected image is printed. However, in the screen shown in FIG. 9, when the input button 92 is operated so that printing of a plurality of sheets is instructed, printing can be performed by repeatedly using the parameters calculated at step S22. In this case, when the same image is to be printed, the parameters are reused so that processing speed is improved.

In the above-mentioned embodiments, an image (preview image) for which decoding processing is completed is displayed on the LCD of the printing apparatus 11 main body. However, the image may be displayed on an LCD of a digital camera connected to the printing apparatus 11 or alternatively on a television receiver or a host computer as well as connected to the printing apparatus 11.

In the above-mentioned embodiments, image data is printed intact. However, when a part of the image data is to be printed in an expanded or reduced manner, sampling processing may be executed when the expanded or reduced image data is displayed on the LCD 17. In this case, appropriate correction can be performed on the basis of the image after adjustment.

In the above-mentioned embodiments, the processing shown in FIG. 3 is executed by the printing apparatus 11 or the printing apparatus 211.

However, the processing may be executed by a host computer connected to the printing apparatus 11 or the printing apparatus 211.

The processing can be executed by a computer. In this case, a program is provided to describe the content of a processing that the printing apparatus executes. A computer executes the program whereby the processing is performed In the computer. The program, which describes the content of the processing, can be recorded in a recording medium, which can be read by a computer. A recording medium, which can be read by a computer, includes a magnetic recording system, an optical disk, a magneto-optical recording medium, a semiconductor memory, etc. The magnetic recording system includes a hard disk drive (HDD), a floppy disk (FD), a magnetic tape, etc. The optical disk includes a DVD, a DVD-RAM, a CD-ROM, a CD-R/RW (Rewritable), etc. The magneto-optical recording medium includes an MO (magneto-Optical disk), etc.

In case of distribution of programs, portable recording media, such as DVD, CD-ROM, etc., with the programs recorded are sold. Also, programs are stored in a storage device of a server computer, and the programs can be transferred to other computers from the server computer.

A computer that executes programs stores in its own storage device programs recorded in a portable recording medium, or programs transferred from the server computer. The computer reads the programs from its own storage device to execute a processing according to the programs. In addition, the computer can read the programs directly from a portable recording medium to execute a processing according to the programs. Also, the computer can also execute a processing sequentially according to the received programs each time a program is transferred from the server computer.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A printing method, comprising:
specifying a coded image data to be printed;
decoding the coded image data to generate a preview image;
displaying the preview image;
generating print information to be required to print an image corresponding to the preview image without an instruction for printing the image; and
printing the image based on the print information when the instruction is received.

2. The printing method as set forth in claim 1, further comprising:
sampling pixels from an original image which is obtained by the decoding to generate sampling data serving as the print information;
calculate a correction parameter with reference to the sampling data when the instruction is received; and
correcting the original image based on the correction parameter.

3. The printing method as set forth in claim 1, further comprising:
sampling pixels from an original image which is obtained by the decoding to generate sampling data;
calculate a correction parameter serving as the print information with reference to the sampling data when the instruction is received; and
correcting the original image based on the correction parameter.

4. The printing method as set forth in claim 1, further comprising:
generating restoring information during the decoding, the restoration information adapted to restore a part of an original image to which processing is first applied, in a case where the image is obtained by rotating the original image; and
obtaining the original image by the decoding; and
rotating the original image to obtain the image based on the restoring information when the instruction is received.

5. The printing method as set forth in claim 1, further comprising:
displaying a thumbnail image corresponding to the coded image data, the thumbnail image being adapted to be specified to specify the coded image data.

6. The printing method as set forth in claim 1, further comprising:
terminating the decoding in a case where another coded image data is specified during the decoding; and
decoding the another coded image data to generate the preview image.

7. The printing method as set forth in claim 1, further comprising;
dividing the coded image data into a plurality of data pieces each of which corresponds to a part of the image;
decoding one of the data pieces to obtain a decoded data piece corresponding to a part of the preview image;
displaying the part of the preview image; and
repeating the decoding of one of the data pieces and displaying the part of the preview image until the preview image is completed.

8. The printing method as set forth in claim 1, further comprising reusing the print information in a case where the coded image data is again specified.

9. The printing method as set forth in claim 8, further comprising:
storing the print information in a storage.

10. A program product comprising a program adapted to cause a computer to execute the printing method as set forth in claim 1.

11. A printing apparatus, comprising:
a specifier, operable to specify a coded image data to be printed;
a decoder, operable to decode the coded image data to generate a preview image, when the coded image data is specified;
a display, operable to display the preview image;
a generator, operable to generate print information to be required to print an image corresponding to the preview image without an instruction for printing the image; and
a print executer, operable to print the image based on the print information when the instruction is received.
